(19) United States
(12) Patent Application Publication
(10) Pub. No.: US 2013/0229078 A1
(43) Pub. Date: Sep. 5, 2013

(54) CONTROL FOR ROTATING ELECTRICAL MACHINERY

(71) Applicant: SPINLECTRIX INC., Hillsborough, CA (US)

(72) Inventor: Jonathan Forrest Garber, Hillsborough, CA (US)

(73) Assignee: SPINLECTRIX INC., Hillsborough, CA (US)

(21) Appl. No.: 13/842,894

(22) Filed: Mar. 15, 2013

Related U.S. Application Data
(63) Continuation-in-part of application No. 13/280,314, filed on Oct. 24, 2011.
(60) Provisional application No. 61/406,102, filed on Oct. 22, 2010.
(60) Provisional application No. 61/406,103, filed on Oct. 22, 2010.
(60) Provisional application No. 61/406,104, filed on Oct. 22, 2010.
(60) Provisional application No. 61/406,105, filed on Oct. 22, 2010.
(60) Provisional application No. 61/406,107, filed on Oct. 22, 2010.
(60) Provisional application No. 61/406,099, filed on Oct. 22, 2010.

(51) Int. Cl. H02K 7/09

(52) U.S. Cl. CPC H02K 7/09
USPC 310/90.5

(57) ABSTRACT

An example rotating electrical machine includes a stator assembly, a rotor, and a controller. The stator assembly has two or more stator control coils and is centered on a Z axis that is perpendicular to an XY plane defined by mutually perpendicular X and Y axes. The rotor is configured to rotate about a rotational axis that is nominally collinear with the Z axis and has a magnet array that provides a magnetic field configured to pass through the stator control coils. The controller is configured to control the stator control coils to selectively generate magnetic fields that interact with the magnetic field of the magnet array to: control rotation of the rotor about the second axis; and one or both of: control translation of the rotor in the XY plane; and control rotation of the rotor about the X axis and the Y axis.

### CROSS-REFERENCE TO RELATED APPLICATIONS

This patent application is a continuation-in-part of U.S. patent application Ser. No. 13/280,314, filed Oct. 24, 2011, which is incorporated herein by reference.

### FIELD

The present invention generally relates to rotating electrical machinery. More particularly, some example embodiments relate to improved and simplified control of rotating electrical machinery.

### BACKGROUND

A common and essentially universal feature of rotating electrical machinery is the use of electromagnetic effectors or actuators to produce rotational movement as required by a particular application. These electromagnetic effectors or actuators commonly consist of electrically conductive wire that is wound into multiconductor bundles of widely varying topologies, sometimes referred to as coils. Electrical currents are passed through these coils, producing magnetic fields that interact with other magnetic fields and/or magnetic components so as to rotate a portion of a machine sometimes referred to as a rotor. Commonly, these coils have a single function in that they are employed only in producing rotation (as in an electric motor) or changing rotation into electric power (as in a generator).

Examples of rotating electrical machinery that use such electromagnetic effectors or actuators include electric motors and electric generators, which convert electrical energy into mechanical motion and mechanical motion into electrical energy, respectively. In electric motors, currents are driven through one or more electromagnetic coils to create magnetic fields that react against other magnetic fields and/or magnetic materials so as to rotate a portion of the machine commonly called a rotor. In electric generators, a rotor that is caused to rotate by mechanical means interacts with magnetic fields or magnetic elements to induce currents to flow in electromagnetic coils, thereby changing mechanical energy into electrical energy. The electromagnetic coils that are employed in producing rotation or changing rotation into electric power may be referred to as a first category of electromagnetic actuators.

A second category of electromagnetic actuators may be present in some rotating electrical machinery in the form of components that employ electrical power to stabilize the position of a rotor. Common examples include machines that incorporate magnetic bearings in which all or a portion of the magnetic actuator forces are generated by electromagnetic coils. It is often the case that such electromagnetic actuators are dedicated components, that is, they perform no other function beyond their use in rotor position control.

Rotating electrical machinery with magnetic bearings are often referred to as “bearingless” systems. On inspection, these bearingless systems are seen to exhibit the most basic function of a bearing, and are thus not truly bearingless. In this regard, the basic function of bearings and some of the detrimental aspects of their use in rotating machinery will now be described.

It is common with rotating electrical machinery to constrain the rotor within particular position limits during operation. For example, mechanical, magnetic, and/or other bearings are commonly used to support rotors in motors and generators so that the rotor is separated from stationary components at all times during machine operation.

A rotor exhibits a principal axis of rotation, defined by the rotor design and by the particular distribution of mass in the components and materials that make up the rotor. This axis of rotation may be termed the inertial axis of rotation, and is the axis about which the rotor would spin in the absence of any perturbing outside force. Bearings operate by confining a rotor to a particular axis of rotation determined by the bearing design and construction, and by the interaction of the bearings with the rotor they support. This axis, termed the geometric axis of rotation, often differs from the rotor's inertial axis of rotation.

To the extent that a rotor's inertial axis of rotation differs from its geometric axis of rotation, forces are developed that are resolved at the bearings, which are the mechanical interface between the spinning rotor and the stationary environment. Non-identity between inertial and geometric axes may occur as instances of three conditions or combinations thereof: simple displacement in which the two axes are parallel and therefore not intersecting, an angular displacement in which the two axes are not parallel but do intersect at one point, or an angular displacement in which the two axes are not parallel and do not intersect at any point. In the art of rotating machinery, such differences are commonly termed as “imbalance” of the rotor. To the extent that the rotor is imbalanced, that is, to the extent that its inertial rotational axis differs from a bearing-imposed geometric axis, forces are developed at the bearings that cause wear, destructive resonances, and other detrimental effects known in the art of rotating machinery.

Bearings comprise a wide range of technologies: they may be fabricated from rigid materials (e.g., sleeve, journal, and rolling element bearings), or they may employ fluids (e.g., film bearings, air bearings), or they may employ magnetic forces to preclude physical contact between moving and stationary components. Magnetic bearings may be passive or actively controlled. Different bearing technologies may be mixed within a single system to place a rotor or rotors at position(s) required for successful device operation.

While bearings comprise a great variety of technologies, they all share a common characteristic: when the rotational axis of the rotating assembly which they support becomes non-coincident with the geometric rotational axis imposed by a bearing, bearings exert a force on the rotating assembly to maintain the inertial axis within an acceptable deviation from the geometric axis. This is the fundamental commonality among bearings of widely differing technologies. In solid material bearings, counterforces are generated when the bearing materials are deformed by rotational forces, and the magnitudes of counterforces are controlled by the degree of noncoincidence between inertial and geometric rotational axes, the rotational rate, and the properties of the bearing materials. In film bearings, counterforces are generated by compression of a thin lubricating fluid, and the magnitude of these forces are determined in part by the particulars of the fluid in addition to rotational rate and the disparity between inertial and geometric rotational axes. In passive magnetic bearings, counterforces are generated by the change in distance between magnetic elements, which may mediate a change in the force between two permanent magnets, or a change in the force between a magnet and a moving conductor. In active magnetic bearings, counterforces may be generated by changing the magnitude and/or direction of electric currents through conductive elements in response to drive signals computed from sensors that detect departures of a rotor from its desired position. In all these cases, the counterforces developed by bearings are (a) synchronous with rotation of the rotor and (b) increase and decrease according to the degree of departure of the rotor from its desired position.

The prior art in rotating electrical machinery demonstrates the long use of bearings despite the significant disadvantages and limitations they confer. The prior art also demonstrates the use of active magnetic bearings that require effector components such as actuator coils that do not contribute to the primary function of the rotating electrical machine of which they are a part.

FIG. 1A schematically illustrates an example rotating electrical machine 100A (hereinafter “machine 100A”) including mechanical bearings 102A, 102B (collectively “mechanical bearings 102”). In the illustrated embodiment, the machine 100A is implemented as an electrical motor including an electrical drive source 104 (hereinafter “drive source 104”). Alternately, the machine 100A may be implemented as an electrical generator by substituting an electrical load for the drive source 104, in which case magnets within a rotor of the machine 100A may induce electrical currents in stator windings, thereby converting the rotor's kinetic energy into electrical energy.

The machine 100A includes a stator assembly 106A with a shaft 106B extending from both ends thereof and fixing the stator assembly 106A to a stationary stator mounting plate 108. The stator assembly 106A includes two electromagnetic coils or sets of windings. More generally, the stator assembly 106A may include N electromagnetic coils. The electromagnetic coils may be energized according to drive currents generated by per-coil drivers 104A of the drive source 104 in response to control signals generated by a controller 104B of the drive source 104. The controller 104B may be coupled to an electrical input 110.

The stator assembly 106A includes a long axis 112 that is parallel to a Z axis of an arbitrarily-defined coordinate system 114. The coordinate system 114 includes mutually perpendicular X, Y and Z axes.

The machine 100A additionally includes a rotor 116A that may be substantially cylindrical or more generally may have any shape that is substantially radially symmetric. The rotor 116A includes an axis of rotation 118 that is substantially concentric with the long axis 112 of the stator assembly 106A. The rotor 116A is configured to rotate or spin about its axis of rotation 118 around the stator assembly 106A during normal operation, as generally denoted at 120.

The rotor 116A includes magnets 122 implemented as permanent magnets, electromagnets, or any combination thereof. The magnets 122 provide a magnetic field. In operation, the magnetic field of the magnets 122 interacts with magnetic fields generated by energizing the electromagnetic coils of the stator assembly 106A, thereby generating a torque on the rotor 116A and causing the rotor 116A to rotate or spin about the stator assembly 106A.

The spinning rotor 116A is stabilized in space and rotatably supported by the mechanical bearings 102, including an upper bearing 102A and a lower bearing 102B that are attached to the shaft 106B. The mechanical bearings 102 constrain the rotor 116A in translation along the X, Y, and Z axes, and constrain the rotor in tilt about the X and Y axes (often referred to, respectively, as θₓ and θ_{w}). The mechanical bearings 102 additionally permit rotation of the rotor 116A about the Z axis in either direction. An example of a class of mechanical bearings that may accomplish such functions is referred to as a double angular contact ball bearing, which may sustain loads against movement in three axes simultaneously. As explained above, counterforces developed by the mechanical bearings 102 are (a) synchronous with rotation of the rotor 116A and (b) increase and decrease according to the degree of departure of the rotor 116A from its desired position.

FIG. 1B schematically illustrates an example rotating electrical machine 100B (hereinafter “machine 100B”) including active magnetic bearings (AMBs) 124A, 124B (collectively “AMBs 124”). The machine 100B of FIG. 1B is similar in many respects to the machine 100A of FIG. 1A and includes many of the same or identical components, as denoted by the use of identical reference numbers. For example, similar to the machine 100A of FIG. 1A, the machine 100B of FIG. 1B includes a drive source 104, a stator assembly 106A including electromagnetic coils, a shaft 106B, a stationary stator mounting plate 108, and magnets 122. Moreover, although illustrated as an electrical motor, the machine 100B may instead be implemented as an electrical generator by substituting an electrical load for the drive source 104.

The machine 100B additionally includes a rotor 116B that is generally similar to the rotor 116A of FIG. 1A, except that the rotor 116B includes upper and lower magnets 126A, 126B (collectively “magnets 126”) or magnet assemblies coupled thereto which respectively form a part of an upper AMB 124A and a lower AMB 124B. The upper AMB 124A additionally includes two X axis upper bearing coils 128A, 128B extending radially from the shaft 106B in opposite directions parallel to the X axis and two Y axis upper bearing coils 130A, 130B (only one is depicted in FIG. 1B) extending radially from the shaft 106B in opposite directions parallel to the Y axis. Analogously, the lower AMB 124B additionally includes two X axis lower bearing coils 128C, 128D extending radially from the shaft 106B in opposite directions parallel to the X axis and two Y axis lower bearing coils 130C, 130D (only one is depicted in FIG. 1B) extending radially from the shaft 106B in opposite directions parallel to the Y axis. The four X axis bearing coils 128A-128D are collectively referred to hereinafter as X axis bearing coils 128, while the four Y axis bearing coils 130A-130D are collectively referred to hereinafter as Y axis bearing coils 128.

The machine 100B further includes upper AMB drive electronics 132A and lower AMB drive electronics 132B (collectively “drive electronics 132”). The upper AMB drive electronics 132A may be communicatively coupled to the upper AMB 124A, while the lower AMB drive electronics 132B may be communicatively coupled to the lower AMB 124B. One or more sensors, processors, and/or other components associated with the AMBs 124 may also be included in the machine 100B, although they have been omitted from FIG. 1B for clarity. The machine 100B may additionally include one or more components for constraining the Z axis positioning of the rotor 116B, which components have similarly been omitted from FIG. 1B for clarity. The use of AMBs 124 in the machine 100B of FIG. 1B may substantially eliminate mechanical wear associated with mechanical bearings, such as the mechanical bearings 102 of FIG. 1A.

In operation, the drive electronics 132 selectively energize the X axis bearing coils 128 and the Y axis bearing coils 130 to generate magnetic fields that interact with magnetic fields of the magnets 126 to ultimately constrain the rotor 116B in translation along the X and Y axes, and to constrain the rotor 116B in tilt about the X and Y axes, e.g., θₓ and θ_{y}. For example, when energized, each of the X axis bearing coils 128 and/or Y axis bearing coils 130 may attract the magnets 126 attached to the rotor 116B and thereby cause the rotor 116B to move in the X or Y axis with respect to the stationary stator assembly 106A, depending on which of the X axis bearing coils 128 and/or Y axis bearing coils 130 are energized. Thus, in the embodiment of FIG. 1B, two coils are required to effect bidirectional translation on the X axis and two coils are required to effect bidirectional translation on the Y-axes. Moreover, two sets of four coils, including one at each end of the stator assembly 106A (e.g., one set of four coils in the upper AMB 124A and one set of four coils in the lower AMB 124B), are required to control tilt, or θₓ and θ_{y}, of the rotor 116B. Thus, the machine 100B of FIG. 1B requires a total of 8 bearing coils 128, 130, along with drive electronics 132 and/or other associated components to provide rotor position control in only four degrees of freedom, e.g., X, Y, θₓ, and θ_{y}.

Thus, in the machine 100B of FIG. 1B, the AMBs 124, the drive electronics 132, and/or other associated components are provided in addition to the electromagnetic coils of the stator assembly 106A and the drive source 104 and do not contribute to the primary function of the machine 100B, which is the conversion of electrical energy to kinetic energy (in the case of an electrical motor) or the conversion of kinetic energy to electrical energy (in the case of an electrical generator). Moreover, the two AMBs 124, drive electronics 132, and/or other associated components can significantly increase the cost and complexity of the machine 100B, and/or are subject to failure, thereby reducing the reliability of the machine 100B compared to other machines in which such components are not necessary.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

The embodiments discussed herein generally relate to improved and simplified control of rotating electrical machinery. Some example embodiments reduce and/or eliminate the need for bearings to maintain the position of a rotor, and do so without requiring additional current-carrying coils to accomplish this function, instead employing coils that are already incorporated into a rotating electrical machine to effect its rotary operation.

Accordingly, an example embodiment includes a rotating electrical machine including a stator assembly, a rotor, and a controller. The stator assembly has two or more stator control coils and is centered on a Z axis that is perpendicular to an XY plane defined by mutually perpendicular X and Y axes. The rotor is configured to rotate about a rotational axis that is nominally collinear with the Z axis and has a magnet array that provides a magnetic field configured to pass through the two or more stator control coils. The controller is configured to control the two or more stator control coils to selectively generate magnetic fields that interact with the magnetic field of the magnet array to: control rotation of the rotor about the second axis; and one or both of: control translation of the rotor in the XY plane; and control rotation of the rotor about the X axis and the Y axis.

Another example embodiment includes a method of providing multi-axis control in a rotating electrical machine. The method includes providing a rotating electrical machine including a stator assembly having multiple stator control coils and a rotor having a magnet that provides a magnetic field that passes through the stator control coils. The rotor has at least two degrees of freedom, including a first degree of freedom including rotation about a Z axis, and any one or more of: a second degree of freedom including translation along the Z axis; a third degree of freedom including rotation about an X axis perpendicular to the Z axis; a fourth degree of freedom including translation along the X axis; a fifth degree of freedom including rotation about a Y axis perpendicular to each of the X and Z axes; and a sixth degree of freedom including translation along the Y axis axes. The method also includes operating the stator control coils to control the rotor with respect to the first degree of freedom, including increasing or decreasing a rotational rate of the rotor about the Z axis, wherein the rotating electrical machine functions as an electrical motor or an electrical generator by rotation of the rotor about the Z axis. The method also includes operating at least some of the same stator control coils that control the rotor with respect to the first degree of freedom to control the rotor with respect to any one or more of the first, second, third, fourth, fifth, or sixth degrees of freedom.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A schematically illustrates an example rotating electrical machine including mechanical bearings;

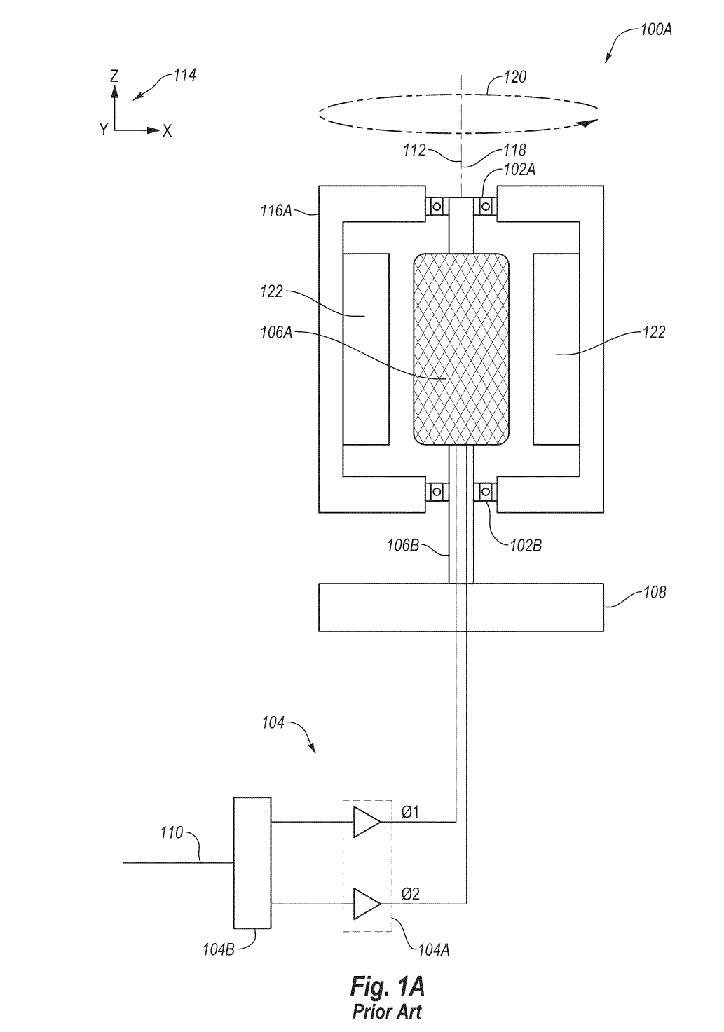

FIG. 1B schematically illustrates an example rotating electrical machine including active magnetic bearings;

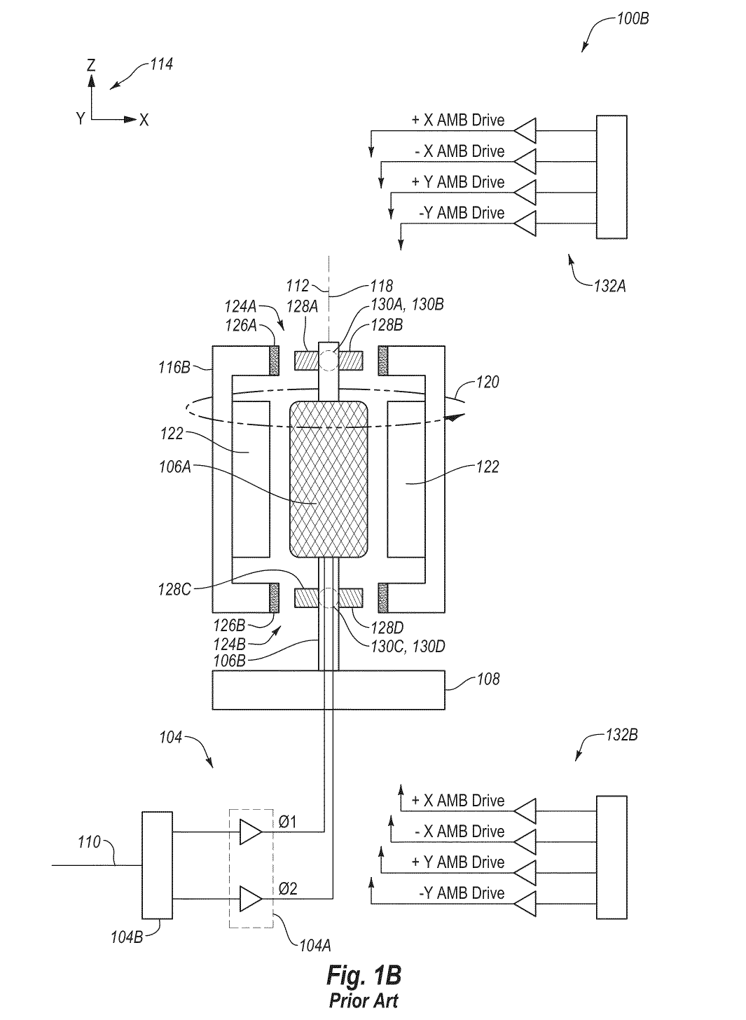

FIG. 2 schematically illustrates an example two-phase rotating electrical machine (hereinafter “machine”) according to some embodiments described herein;

FIG. 3A is an overhead view of an example embodiment of the magnet array that may be included in the machine of FIG. 2;

FIG. 3B is a perspective view of a magnet that may be included in the magnet array of FIG. 3A;

FIG. 3C is a graph of magnetic field intensity as a function of distance from a center C of the magnet array of FIG. 3A in an XZ plane;

FIGS. 4A-4B depict a front view and a side view, respectively, of an example embodiment of a stator control coil that may be included in the stator assembly of FIG. 2;

FIG. 5A is a schematic view along a Z axis of an example embodiment of the stator assembly of FIG. 2;

FIG. 5B is a schematic side view illustrating a relative orientation of two of the stator control coils in the stator assembly of FIG. 5A;

FIG. 5C illustrates example electrical interconnections of the stator control coils of the stator assembly of FIG. 5A;

FIGS. 6A and 6B include cross-sectional views of the machine of FIG. 2 in a plane parallel to an XY plane; and

FIG. 7 illustrates a perspective view of a stator coil with a nonplanar stator coil geometry.

### DETAILED DESCRIPTION

Some embodiments described herein include rotating electrical machinery that employs electromagnetic actuator coils for multiple functions. For example, electromagnetic coils that impart rotation to a rotor are also used to position the rotor. This confers at least two important, independent benefits: it reduces the number of coils required to rotate and control the position of a rotor, and it enables control of the rotor without use of bearings. Reduction of the number of control coils to effect rotation and position control confers additional benefits in reducing the number of electrical drive subsystems needed, simplifies mechanical construction of the machine, and improves reliability through reduction of component count.

In an example embodiment, electrical coils already present in the machine are employed to provide up to 6 axes of position and attitude control of the rotor in addition to being employed for their normal function of effecting changes in rotation rate of the electrical machine. Specifically, the machine may include a rotating portion, such as a rotor, that rotates about the Z axis, where the rotation is driven by electrical coils that deliver energy to the rotating portion, or where the electrical coils extract energy from the rotating portion. The electrical coils, together with one or more other components, may cooperate to perform two or more of the following functions: (1) effect translational positioning of the rotating portion along at least one of up to three mutually perpendicular X, Y, and/or Z axes and/or effect increases, (2) effect tilting of the rotating portion in either or both of the X and Y axes, and (3) effect normal operation of the rotating portion, including increases and/or decreases in the rate of rotation about the Z axis of the rotating portion. The foregoing functions may be achieved without the use of dedicated electrical coils beyond those used to effect changes in the rate of rotation about the Z axis.

Although some embodiments will be described in terms of an electrical motor or generator that has a stationary set of electrical coils surrounded by a moving magnetic field that is generated by moving permanent magnets, it will be appreciated that the principles described herein are applicable to rotating electrical machines in which electrical coils are rotating rather than stationary, and/or in which changing magnetic fields are provided by appropriately driven electromagnets alone or in combination with permanent magnets.

An example embodiment will be described in terms of a two-phase electrical motor or generator that employs a bipolar cylindrical magnetic field. However, the invention is not limited to two-phase rotating electrical machinery. Indeed, the invention may be applied in single-phase motors or generators. The invention may also be applied in electrical motors or generators exhibiting three or more electrical phases.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

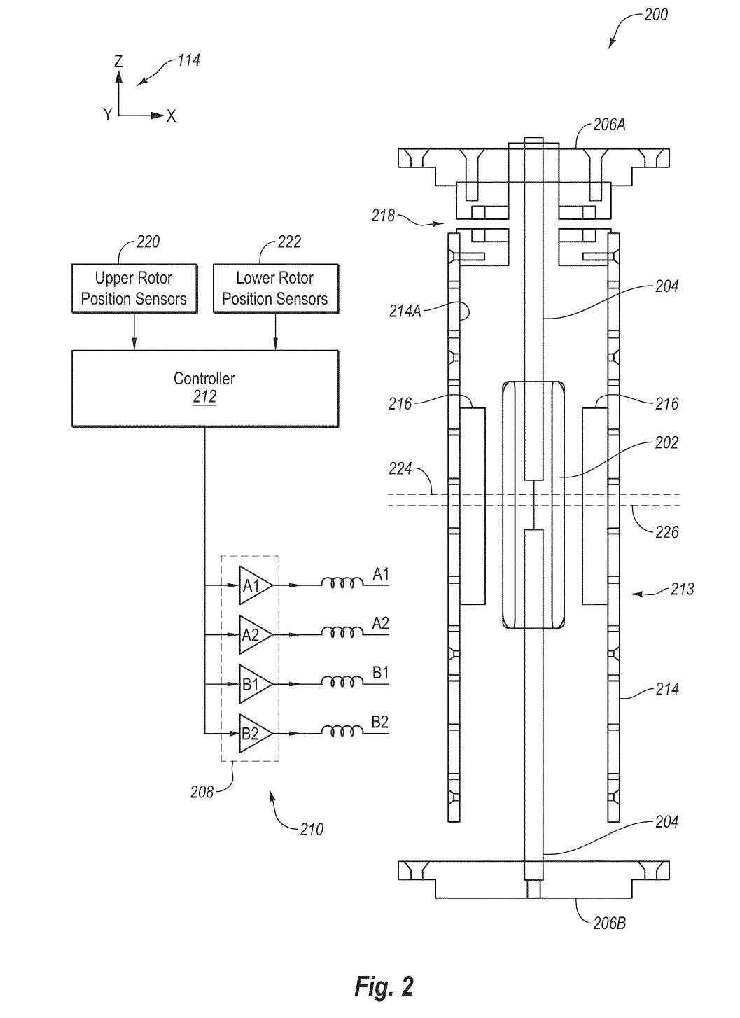

FIG. 2 schematically illustrates an example two-phase rotating electrical machine 200 (hereinafter “machine 200”) according to some embodiments described herein. While various components are illustrated in FIG. 2, the machine 200 may alternately or additionally include similar but different components than those illustrated and/or other components not illustrated in FIG. 2. Although depicted as an electrical motor, the machine 200 may alternately be implemented as an electrical generator.

The machine 200 includes a stator assembly 202 with a shaft 204 extending from both ends thereof and fixing the stator assembly 202 to stationary upper and lower stator mounting plates 206A, 206B. The stator assembly 202 includes four electromagnetic coils or stator control coils. More generally, the stator assembly 202 may include N stator control coils. The stator control coils may be energized according to drive currents generated by percoil drivers 208 of a drive source 210 in response to control signals generated by a controller 212 of the drive source 210.

The machine 200 additionally includes a rotor 213 configured to rotate about the stator assembly 202. The rotor 213 includes a rotor tube 214 and, although not shown, may also include one or more additional masses coupled to the rotor tube 214 to increase the amount of kinetic energy that may be developed by rotation of the rotor 213 within the machine 200. In some embodiments, the rotor tube 214 includes 6061 T6 aluminum alloy and has a nominal overall length (e.g., in the Z direction) of 12 inches, an inner diameter of three inches, and an outer diameter of 3.5 inches. The rotor tube 214 is aligned with its long axis parallel to and coincident with the Z axis. The Z axis is the principal axis of rotation of the rotor tube 213 in the present example.

Fixed to an inner surface 214A of the rotor tube 214 is a magnet array 216. The magnet array 216 includes an eight segment dipolar permanent magnet Halbach array in some embodiments, an example of which is described in more detail below. It will be understood by those skilled in the art that other configurations of permanent magnets may be employed to meet particular requirements, and that such operable configurations do not limit this invention.

At the upper (+Z axis) end of the rotor tube 214, the machine 200 includes a means 218 for suspending the rotor 213 (hereinafter “suspending means 218”), including the rotor tube 214, against the force of gravity. In the present example, the suspending means 218 includes a conventional magnetic levitator as is known in the art of magnetically suspended rotating machinery. Other means of supporting the rotor 213, such as radially compliant mechanical means, may be employed, and such operable suspension means do not limit this invention.

The stator assembly 202 including the four stator control coils is positioned within a hollow interior of the rotor tube 214 so that the stator control coils substantially intersect a magnetic field created by the magnet array 216, and so that the center of force of the magnetic field created by the magnet array 216 does not coincide with the center of force of the stator control coils when the stator control coils are energized. The shaft 204 or other mechanical means are provided which support the stator assembly 202 radially concentric to the interior of the rotor tube 214 and fix the stator assembly 202 with respect to rotation about and translation along the Z axis.

The machine 200 additionally includes one or more upper rotor position sensors 220 and/or one or more lower rotor position sensors 222. Each of the upper and lower rotor position sensors 220, 222 may include, but is not limited to an optical, inductive, capacitive, acoustic and/or other position sensor. In the present example, the upper and lower rotor position sensors 220, 222 each include one or more Hall sensors to sense the magnitude and direction of a rotating magnetic field produced by the magnet array 216. For example, the upper rotor position sensors 220 may include four Hall sensors mounted at or near an upper Z axis extreme of the shaft 204 coupled to the upper stator mounting plate 206A, while the lower rotor position sensors 222 may similarly include four Hall sensors mounted at or near a lower Z axis extreme of the shaft 204 coupled to the lower stator mounting plate 206B.

The upper rotor position sensors 220 and the lower rotor position sensors 222 are positioned such that the local magnetic field is simultaneously measured in the +X, −X, +Y, and −Y directions at each end of the stator assembly 202. The upper rotor position sensors 220 and the lower rotor position sensors 222 generate and provide data to the controller 212 from which the controller 212 may determine the position of the rotor 213 with respect to the X, Y, and Z axes, and the angular excursion of the rotor 213 about the X and Y axes, and the rotational position of the rotor 213 in its rotation about the Z axis. The data generated by the upper rotor position sensors 220 and the lower rotor position sensors 222 may be made available to the controller 212 at sufficiently frequent intervals to enable the controller 212 to compute the state of the rotor 213 and to compute corrective signals, if required. The corrective signals may be applied to the stator control coils of the stator assembly 202 to adjust the state of the rotor 213, as needed, which may include one or more of increasing or decreasing a rotational rate of the rotor 213 about the Z axis, translating the rotor 213 with respect to the stationary components of the machine 200 in the X, Y, and/or Z directions, and tilting the rotor 213 about the X and/or Y axes.

It will be apparent that no particular data acquisition interval may be specified, as the interval will vary with the rotor's rotational speed, the rapidity with which computation of the rotor's state may be made, and the magnitude of control authority available to the rotor positioning system, as well as the requirement, if any, that the system maintain rotor position in the presence of exceptional disturbances that may arise during operation of the rotor. An example of exceptional disturbances would be the imposition of forces on an operating flywheel due to earth movements (e.g., earthquakes) that couple to the machine 200.

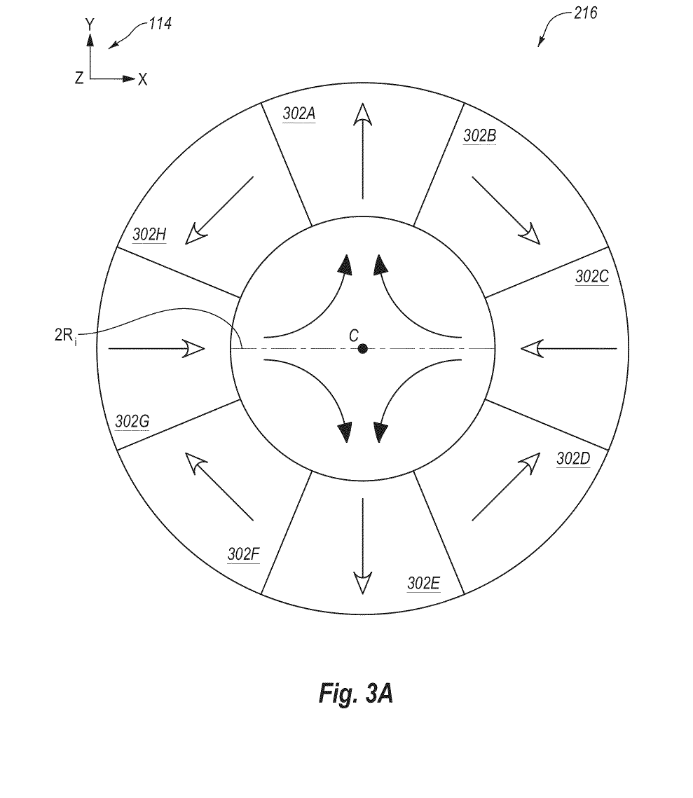

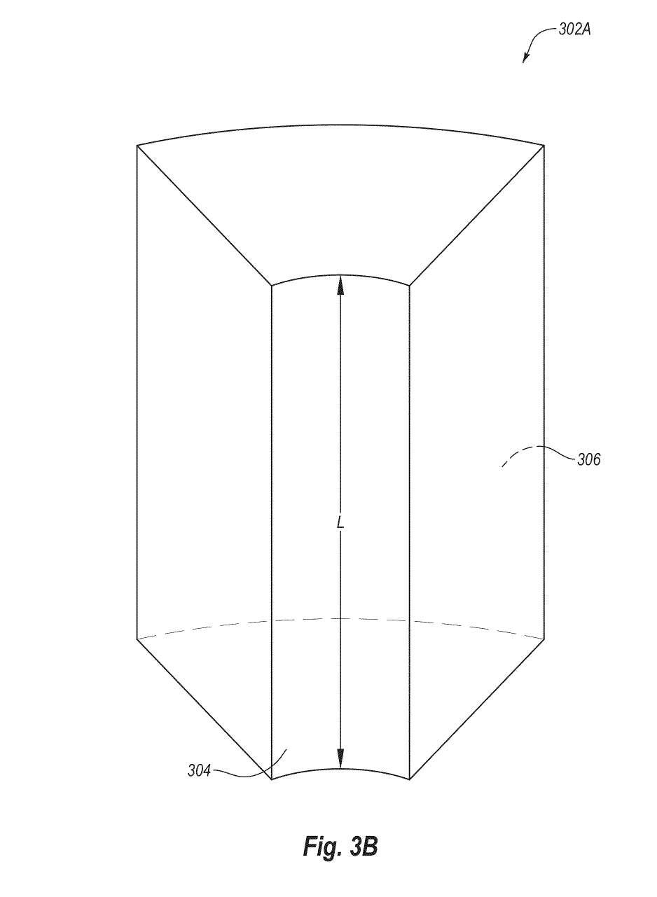

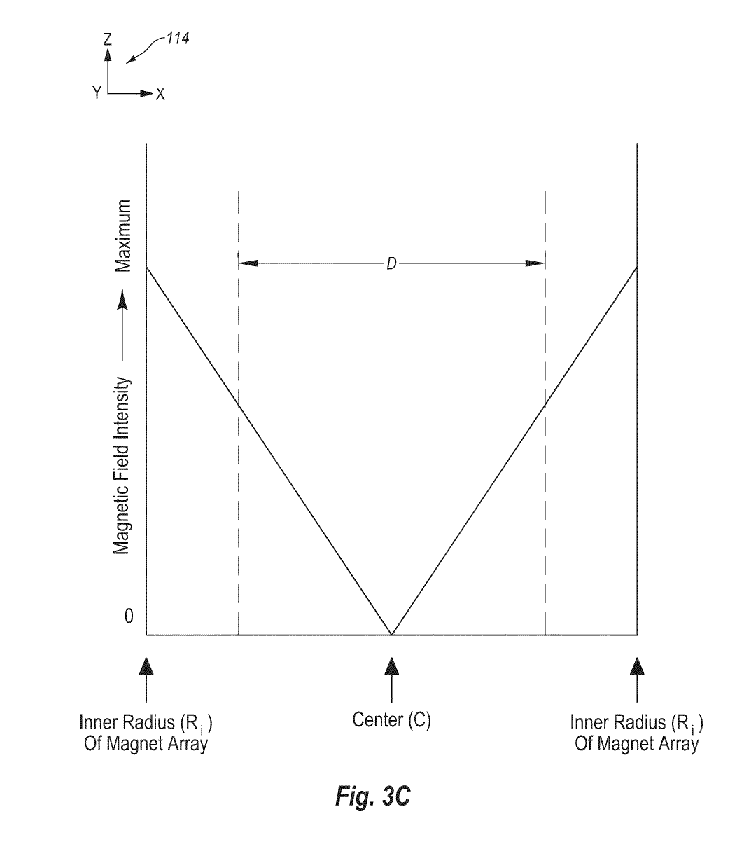

FIG. 3A is an overhead view of an example embodiment of the magnet array 216 that may be included in the machine 200 of FIG. 2, and FIG. 3B is a perspective view of a magnet 302A that may be included in the magnet array 216 of FIG. 3A, all arranged in accordance with at least some embodiments described herein. With combined reference to FIGS. 3A-3B, the magnet array 216 includes eight individual magnets 302A-302H (collectively “magnets 302”). The magnets 302 are arranged to form a hollow cylinder having an inner diameter of 2Rᵢ each magnet 302 having the form illustrated in FIG. 3B. Magnetization vectors within each magnet 302 are shown in FIG. 3A by arrows that lie within the outline of each magnet 302, the arrowhead corresponding to magnetic north. Curved lines with solid arrowheads within the hollow interior of the magnet array 216 array indicate the configuration of the magnetic field within this region as projected onto the XY plane. The configuration of the magnet array 216 is sometimes referred to as a dipolar cylindrical Halbach array.

In some embodiments, each of the magnets 302 has a length L (e.g., parallel to the Z axis) of four inches, an inner semi-cylindrical surface 304 having a radius of curvature of Rᵢ, which may be equal to 25.4 millimeters (mm), and an out semi-cylindrical surface 306 having a radius of curvature of 43.4 mm. In the magnet array 216, the inner semi-cylindrical surfaces 304 of all of the magnets 302 form an inner cylindrical surface of the magnet array 216 including a minimum radius of the rotor 213 of the machine 200 of FIG. 2. It will be apparent, with the benefit of the present disclosure, that a central volume of cylindrical shape is left open by this construction. The magnets 302 may be fabricated from C8 or equivalent grade ceramic magnetic material, and/or may be fabricated from different magnetic materials as may be determined by particular engineering needs.

FIG. 3C is a graph of magnetic field intensity as a function of distance from a center C of the magnet array 216 of FIG. 3A in the XZ plane, arranged in accordance with at least some embodiments disclosed herein. As illustrated, magnetic field intensity is substantially zero at the center of the magnet array 216, and rises along any radius from the center outward to a local free space maximum at the inner cylindrical surface of the magnet array 216 that is collectively formed by the inner semi-cylindrical surfaces 304 of all of the magnets 304. This pattern is also observed in the YZ plane. FIG. 3C additionally illustrates a diameter D of the stator assembly 202.

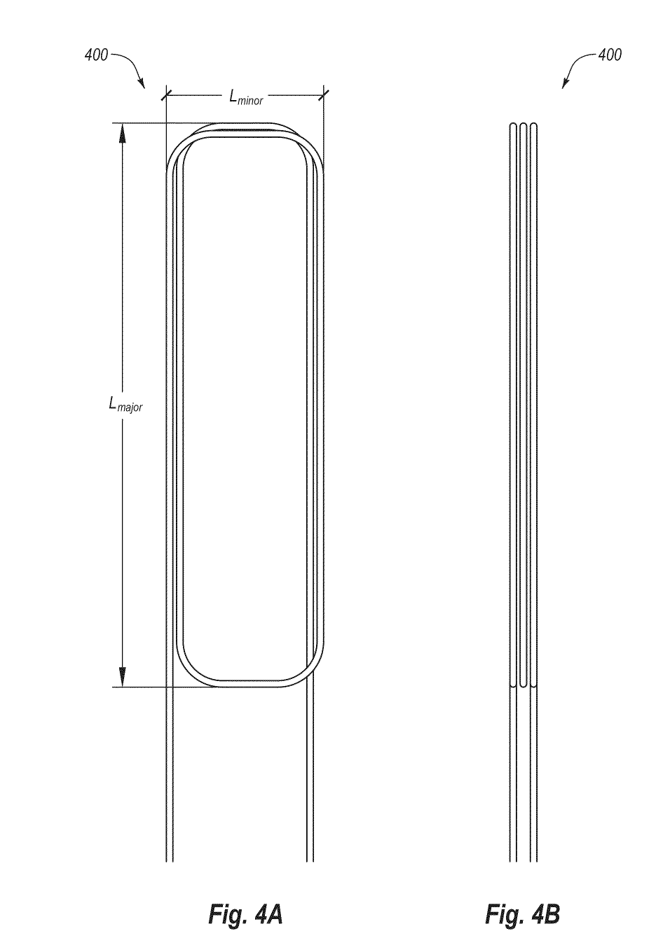

FIGS. 4A-4B depict a front view and a side view, respectively, of an example embodiment of a stator control coil 400 that may be included in the stator assembly 202 of FIG. 2, arranged in accordance with at least some embodiments described herein. For example, the stator assembly 202 may include four stator control coils 400. The stator control coil 400 of FIGS. 4A-4B includes electrically conducting material such as copper wire that allows the flow of electrical current when its leads are connected to an external source of power, such as the drive source 210 of FIG. 2, and which allows the flow of electrical current when subjected to a changing magnetic field and when its leads are connected to an external electrical load (not shown).

The stator control coil 400 has a major length Lₘₐⱼₒᵣ parallel to the Z axis and minor length Lₘᵢₙₒᵣ parallel to the XY plane. Generally, the stator control coil 400 comprises multiple turns of conducting material whose number and physical disposition vary according to the requirements of its particular use.

More particularly, while the stator control coil 400 illustrated in FIGS. 4A-4B is constructed by winding a coil of copper wire less than three turns in order to simply illustrate how the stator control coil 400 is formed, in one embodiment, the stator control coil 400 is constructed by forming 39 turns of #22 gauge copper wire having a thin insulating layer into a coil wound as tightly as is practical. The coil may have a major length Lₘₐⱼₒᵣ of approximately five inches, a minor length Lₘᵢₙₒᵣ of approximately 0.75 inches, and of wire cross section dimensions of approximately 0.5 inches wide x approximately 0.25 inches deep. These dimensions are determined by electrical requirements and are not limiting to the practice of the invention.

The stator control coil 400 is substantially rectangular and planar in overall form. That is, the stator control coil 400 does not exhibit a substantial overall twist apart from those functionally insignificant departures from topological perfection that are incident to practical fabrication of an electrical coil.

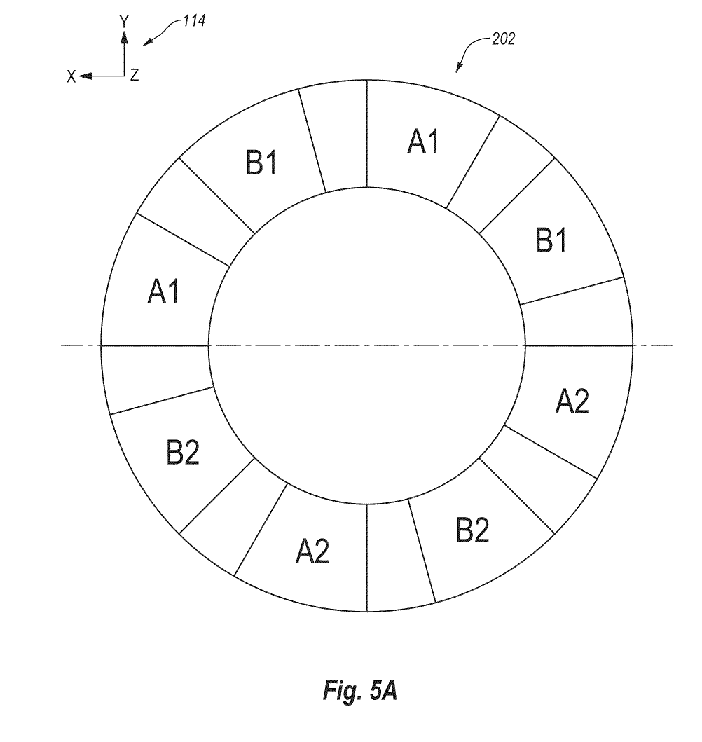

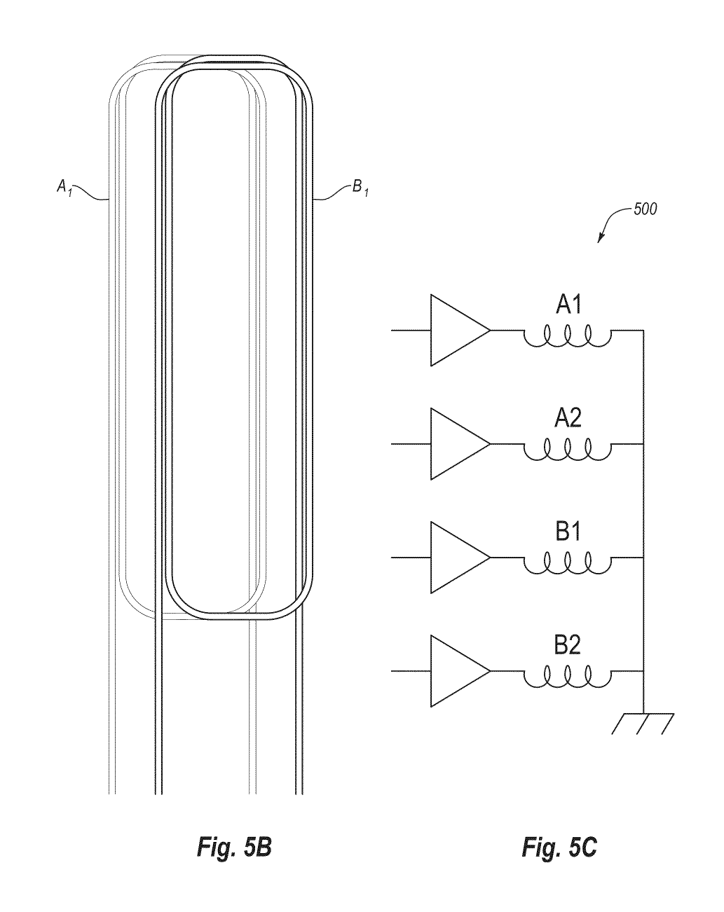

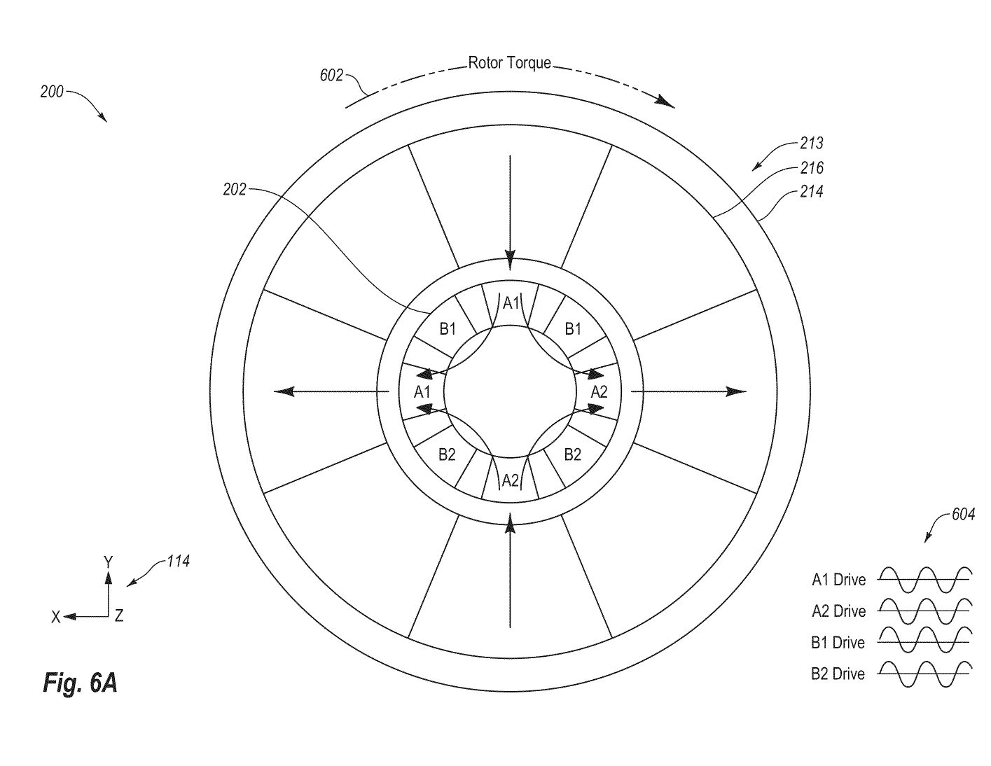

In an example embodiment, four stator control coils 400 are mounted on a stator assembly that provides mechanical support for the stator control coils 400 and which allows electrical connections to be made to each stator control coil 400. The four stator control coils 400 may be disposed upon the stator assembly according to the schematic views presented in FIGS. 5A and 5B. The stator control coils 400 may be controllably electrically energized, and/or controllably connected to electrical loads singly or in combination in order to exert control forces on a rotor.

FIG. 5A is a schematic view along the Z axis of an example embodiment of the stator assembly 202 of FIG. 2, arranged in accordance with at least some embodiments described herein. In the illustrated embodiment, the stator assembly 202 includes four stator control coils A1, A2, B1, and B2 that may each correspond to the stator control coil 400 of FIGS. 4A-4B. FIG. 5B is a schematic side view illustrating a relative orientation of two of the stator control coils A1 and B1 in the stator assembly 202 of FIG. 5A, arranged in accordance with at least some embodiments described herein. The stator control coils A1, A2, B1, B2 may be affixed to a supporting core or form which has been omitted form FIGS. 5A-5B for clarity.

FIG. 5C illustrates example electrical interconnections 500 of the stator control coils A1, A2, B1, B2, arranged in accordance with at least some embodiments described herein. In these and other embodiments, the drive current of each of the stator control coils A1, A2, B1, B2 may be controlled in magnitude, polarity, frequency, and relative phase, or any combination thereof.

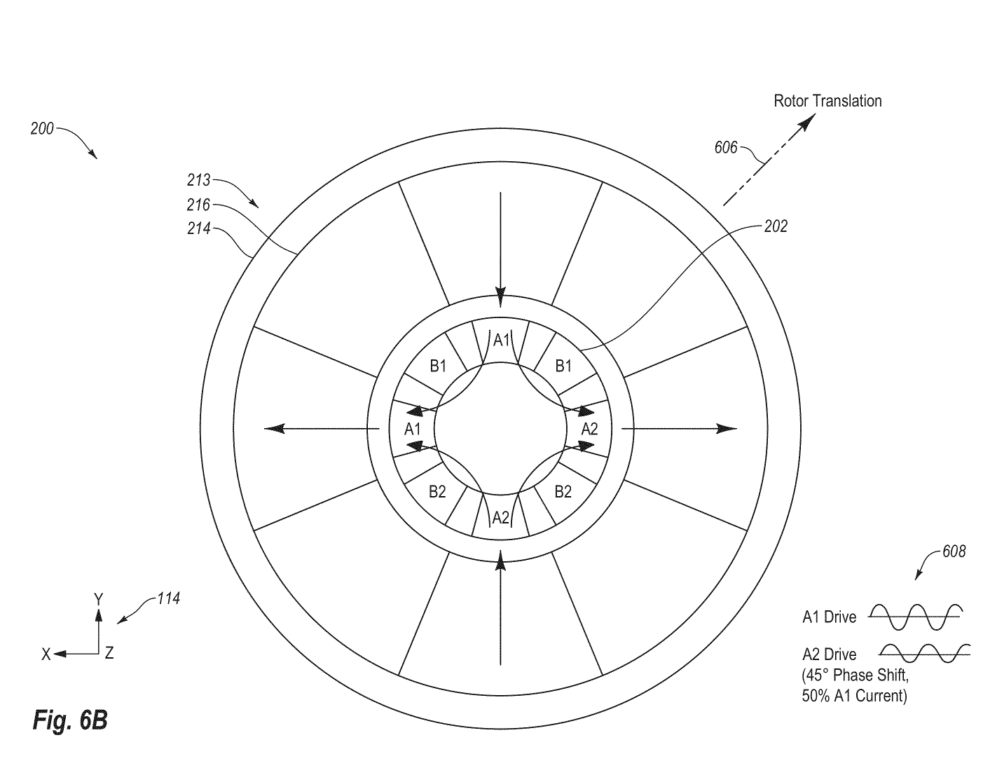

FIGS. 6A and 6B include cross-sectional views of the machine 200 of FIG. 2 in a plane parallel to the XY plane, arranged in accordance with at least some embodiments described herein. The relative positioning of the stator assembly 202—including the stator control coils A1, A2, B1, and B2—and the rotor 213—including the rotor tube 214 and the magnet array 216—is illustrated in FIGS. 6A-6B.

Operation of the machine 200 will next be described with respect to FIGS. 2 and 6A-6B. The following description assumes that the rotor 213 is initially centered radially on the Z axis and is levitated at its desired location along the Z axis, but is at rest with respect to spin, and that the upper rotor position sensors 220 and the lower rotor position sensors 222 each include four Hall sensors mounted at opposite extrema of the shaft 204. A command to spin the rotor 213 is delivered by the controller 212 to the per-coil drivers 208.

The position and stationary state of the rotor 213 are computed by the controller 212 from Hall sensor magnetic field data received from the upper and lower rotor position sensors 220, 222. The controller 212 generates and provides control signals to the per-coil drivers 208 to cause the per-coil drivers 208 to generate drive currents that energize the stator control coils A1, A2, B1, B2 so as to expose the rotor 213 to a substantially pure torque 602 (FIG. 6A), with substantially no net radial translation or tilt forces. In particular, electrical currents of equal magnitude flow through each of the four stator control coils A1, A2, B1, B2, ensuring that each stator control coil develops a magnetic field substantially equal in magnitude to that of each of the other stator control coils A1, A2, B1, B2. A magnitude of the torque 602 may vary from a minimum to a maximum as the magnetic field of the magnet array spins about the stator assembly 202 as the rotor 213 spins.

Example waveforms corresponding to the drive currents that drive the stator control coils A1, A2, B1, and B2 to generate magnetic fields with substantially equal magnitude are denoted at 604 in FIG. 6A. It is apparent, with the benefit of the present disclosure, that under this condition, force vectors that resolve onto the rotor 213 as radial translation forces sum to zero when integrated around the rotor, while force vectors that have nonzero components tangential to the rotor are additive and result in rotation of the rotor 213 with respect to the stator assembly 202. In this instance, the stator control coils A1, A2, B1, B2 function much the same as simple spin-up coils in electric motors known to the art and have no effect on rotator state of the rotor 213 other than rotation about the Z axis.

As the rotor 213 spins about the stator assembly 202, the dipolar magnetic field provided by the magnet array 216 and passing through the stator assembly 202 completes two apparent revolutions for each full rotation of the rotor 213. That is, any given location of the stator assembly 202 will be exposed to opposing poles of the dipolar magnetic field twice for each single rotation of the rotor 213. The Hall sensor magnetic field data generated by the upper and lower rotor position sensors 220, 222 thus varies at twice the rotation rate of the rotor 213 and may be readily used to compute the rotation rate of the rotor 213. In addition, the upper and lower rotor position sensors 220, 222 measure substantially simultaneous values of the local magnetic field along both directions of the X and Y axes at each Z end of the stator assembly 202. Because of the radial variation of magnetic field strength within the magnet array 216 as depicted in FIG. 3C, radial displacement of the rotor 213 may be calculated for two different positions along the Z axis (the two locations occupied by the upper and lower rotor position sensors 220, 222), and therefore radial position and tilt of the rotor 213 may be calculated in the following manner.

Radial motion of the rotor 213 causes a corresponding radial displacement of the magnetic field provided by the magnet array 216. This in turn will change the local magnetic field magnitude measured by the upper and/or lower rotor position sensors 220, 222 in which the radial motion has a vector projection. Thus, if the rotor 213 translates purely along the X axis, the two pairs of Hall sensors (one pair at each end of the stator assembly 202) within the upper and lower rotor position sensors 220, 222 that respond to X axis components of the local magnetic field will measure different values from those measured prior to the translation along the X axis. In particular, Hall sensors that are brought into closer proximity with the magnet array 216 will measure greater magnetic field strength, while those Hall sensors that are positioned further away from the magnet array 216 will measure a lower magnetic field strength. This magnetic field strength data, when combined with known positions of the Hall sensors, can be used to compute the magnitude and direction of a radial translation of the rotor 213, and can also be used to computer whether the rotor 213 is tilting about the X and/or Y axes. In the latter case, the change in magnitudes of Hall sensor signals may differ between the two sets of Hall sensors at the two Z ends of the stator assembly 202. The variation may indicate different magnitudes of radial translation at the corresponding Z axis positions of the rotor 213, which defines a tilt of the rotor 213 about the X and/or Y axis. Further, temporal analysis of position states of the rotor 213 as calculated from Hall sensor data can quantify velocity and acceleration of the rotor 213, which may be incorporated into position control algorithms as part of computation of position correction commands.

Rotor radial motion without torque can be produced by interactions of the magnetic fields generated by one or more of the stator control coils A1, A2, B1, B2 by driving selected ones of the stator control coils A1, A2, B1, B2 with unequal drive currents. An example will be described in which one pair of stator coils (A1 and A2) are driven to produce radial force on the rotor. Example waveforms corresponding to the drive signals that drive the stator control coils A1 and A2 to generate magnetic fields effective to impart radial motion, e.g., rotor translation 606, to the rotor 213 are denoted at 608 in FIG. 6B.

In particular, stator control coils A1 and A2 may be driven by sinusoidal current waveforms 608 having a frequency twice that of the rotation frequency of the rotor 213. This constraint is imposed by the use of a magnet array 216 with a dipolar magnetic field rotating about the stator assembly 202. If both stator control coils A1 and A2 are driven in phase, and with equal currents, no net radial force is developed on the rotor 213. If the stator control coils A1 and A2 are driven in a fixed phase relationship but with different current magnitudes, a radial force is generated in a fixed direction whose magnitude is substantially proportional to the degree of difference in the magnitude of currents that drive the stator control coils A1 and A2. If the phase relationship between the two drive currents is then varied, the direction of the radial force may be selected and directed towards any direction in the XY plane.

It will be apparent that although the direction of this radial force is fixed by the phase relationship between the drive currents, and while the maximum magnitude of this radial force is determined by the difference between the drive current magnitudes, the instantaneous radial force magnitude will vary between zero and its maximum as the rotor 213 spins around the stator assembly 202. The number of times that the radial force will vary from its minimum to its maximum during a single rotation of the rotor 213 is determined by the number of poles of the magnetic field employed. In the present embodiment, the number of magnetic poles is two (a dipolar field), and the radial force therefore reaches its maximum and minimum twice for each rotation of the rotor 213. A similar relationship holds for drive currents in stator control coils B1 and B2, thereby enabling all stator control coils A1, A2, B1, B2 capable of radially positioning the rotor 213 in addition to modifying its rate of rotation. It will be apparent that this additional capability requires no additional electronic components beyond those used to effect changes in rotation rate of the rotor 213.

Referring again to FIG. 2, reference line 224 denotes a location along the Z axis of the center of mass of the rotor 213 and the center of the magnetic field provided by the magnet array 216 (hereinafter “Z axis rotor center of mass and magnetic field center 224”), and reference line 226 denotes a location along the Z axis of the center of the magnetic fields generated by the stator control coils A1, A2, B1, B2 (hereinafter “Z axis of stator control coil magnetic field center 226). It will be further apparent, with the benefit of the present disclosure, that tilt about the X and/or Y axes may be achieved as well using the same set of stator control coils A1, A2, B1, B2. In particular, because of noncoincidence of the Z axis rotor center of mass and magnetic field center 224 with respect to the Z axis of stator control coil magnetic field center 226, a translation force exerted on the rotor 213 by one of the stator control coils A1, A2, B1, B2 individually will develop a torque about the X and/or Y axis, depending on the phase relationship between the stator control coil A1, A2, B1, B2 and the position of the rotor 213, resulting in a controllable rotor tilt.

Embodiments described herein can also provide independent tilt control of a rotor even in the circumstance in which the Z axis center of mass of the rotor and the Z axis center of the stator coil magnetic fields are in fact coincident, in which case a minimal degree of rotor tilt would be afforded. In these and other embodiments, the rotor 213 may include stator control coils each with a nonplanar stator coil geometry in which at least one opposed stator control pair comprises coils that occupy substantially one plane above the midpoint of the stator assembly along the Z axis, and whose construction rotates approximately 90 degrees below said stator midpoint, the two such coils together comprising an assembly that may be electrically excited to provide rotor tilt substantially without rotor translation.

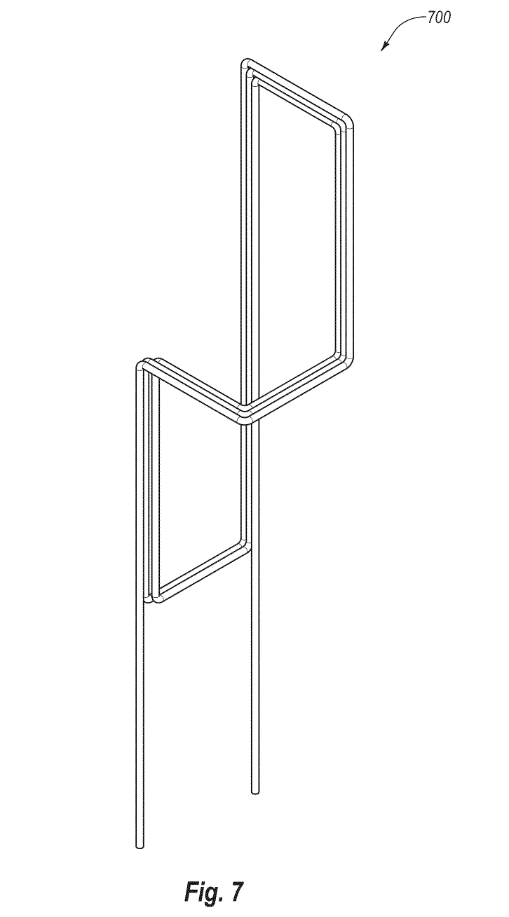

FIG. 7 illustrates a perspective view of a stator coil 700 with such nonplanar stator coil geometry, arranged in accordance with at least some embodiments described herein. The stator control coil 700 may be referred to hereinafter as a “type C coil 700.” As illustrated, the type C coil 700 can generally be divided into a lower loop and an upper loop that is rotated about the Z axis 90 degrees with respect to the lower loop. It will be apparent that the upper loop of the type C coil 700 produces a magnetic field that is rotated about the Z axis by 90° with respect to the lower loop, and that the electromagnetic forces which the upper and lower loops produce in reaction upon the rotor's rotating magnetic field therefore differ in their magnitude and direction. In particular, when the local rotor magnetic field is oriented such that, for example, drive current through the upper loop of the type C coil 700 produces a minimum of electromagnetic force, the drive current through the lower loop of the type C coil 700 will be at a maximum. Because the type C coils 700 are placed on the stator assembly so that they are substantially or mostly symmetric about the center of mass of the rotor and the magnetic field of the rotor along the Z axis, a radial force will be exerted by the lower coil loop on the rotor, and substantially no force will be exerted by the upper coil loop on the rotor. This will result in a torque of the rotor about the X and/or Y axis, according to the particular placement of the type C coil with respect to the local X and Y coordinate axes. Two such coils mounted in opposition on the stator thereby provide independent control of rotor tilt without developing net translational or rotational forces.

It will be apparent that although the above embodiment is described in terms of supplying drive currents to stator control coils A1, A2, B1, B2 to operate the rotor 213 as a motor, the invention may be equally well practiced through controllably connecting the stator control coils A1, A2, B1, B2 to electrical loads, in the case of a flywheel energy storage device, whereby energy may be extracted from the flywheel's rotational kinetic energy while the flywheel rotor's position is controlled as described herein.

It will be apparent that a full six degrees of rotor position control may be achieved by employing a magnetic field configuration that provides a component of divergence along the Z axis as well as the X and Y axes. In this configuration, stator control coils may be configured to provide force components in the + and −Z directions, providing rotor translation along the Z axis. Accordingly, separate dedicated suspending means, such as the suspending means 218 of FIG. 2, may be omitted.

It will be apparent that the invention is operable with rotating electrical machinery that does not employ bearings (as discussed earlier) in which a machine's rotor, which rotates substantially about an inertial axis of rotation, may be controllably positioned using stator control coils that would be incapable of such positioning but for this invention.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include tangible or non-transitory computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A rotating electrical machine, comprising:
a stator assembly having two or more stator control coils, the stator assembly being centered on a Z axis that is perpendicular to an XY plane defined by mutually perpendicular X and Y axes;
a rotor configured to rotate about a rotational axis that is nominally collinear with the Z axis, the rotor having a magnet array that provides a magnetic field configured to pass through the two or more stator control coils;
a controller configured to control the two or more stator control coils to selectively generate magnetic fields that interact with the magnetic field of the magnet array to:
control rotation of the rotor about the second axis; and
one or both of:
control translation of the rotor in the XY plane; and
control rotation of the rotor about the X axis and the Y axis.

2. The rotating electrical machine of claim 1, further comprising:
one or more upper rotor position sensors configured to detect a position of an upper end of the rotor with respect to an upper end of the stator assembly; and
one or more lower rotor position sensors configured to detect a position of a lower end of the rotor with respect to a lower end of the stator assembly;
wherein the controller is configured to control to the two or more stator control coils according to upper and lower position data received from the one or more upper rotor position sensors and the one or more lower rotor position sensors.

3. The rotating electrical machine of claim 2, wherein:
the one or more upper rotor position sensors comprise four Hall sensors positioned at or near the upper end of the stator assembly; and
the one or more lower rotor position sensors comprise four Hall sensors positioned at or near the lower end of the stator assembly.

4. The rotating electrical machine of claim 1, wherein the magnet array comprises a dipolar cylindrical Halbach array.

5. The rotating electrical machine of claim 4, wherein the magnetic field provided by the magnet array is a dipolar magnetic field.

6. The rotating electrical machine of claim 1, wherein the rotational axis comprises an inertial axis of rotation of the rotor.

7. The rotating electrical machine of claim 1, further comprising a dedicated magnetic levitator including a stationary upper levitator mounted to an upper stator mounting plate and a lower levitator mounted to an upper end of the rotor, the upper and lower levitators configured to cooperate to levitate and control a position of the rotor along the Z axis.

8. The rotating electrical machine of claim 1, wherein:
magnetic fields of the magnet array and the stator control coils each have a component parallel to the Z axis; and
the controller is configured to control the two or more stator control coils to selectively generate magnetic fields that interact with the magnetic field of the magnet array to provide six-axis control of the rotor, including:
controlling rotation of the rotor about the second axis;
controlling translation of the rotor along the Z axis
controlling rotation of the rotor about the X axis; and
controlling translation of the rotor along the X axis;
controlling rotation of the rotor about the Y axis; and
controlling translation of the rotor along the Y axis.

9. The rotating electrical machine of claim 1, wherein the rotor comprises a rotor tube having the magnet array coupled to an inner surface thereof, the magnet array defining a cylindrical cavity within which the stator assembly is disposed.

10. The rotating electrical machine of claim 1, wherein the two or more stator control coils comprise:
a first A phase stator control coil A1;
a second A phase stator control coil A2;
a first B phase stator control coil B1; and
a second B phase stator control B2.

11. The rotating electrical machine of claim 10, wherein:
A1 and B1 are positioned in a first half of the stator assembly;
A2 and B2 are positioned in a second half of the stator assembly opposite the first half;
A1 is positioned in the first half of the stator assembly directly opposite A2 in the second half of the stator assembly; and
B1 is positioned in the first half of the stator assembly spaced apart from Al and directly opposite B2 in the second half of the stator assembly.

12. The rotating electrical machine of claim 10, wherein rotation of the rotor about the second axis is controlled by driving A1, A2, B1, and B2 with equal and in-phase drive currents or by connecting A1, A2, B1, and B2 to equal and in-phase electrical loads.

13. The rotating electrical machine of claim 10, wherein translation of the rotor in the XY plane is controlled by driving A1 and A2 and/or B1 and B2 with unequal and out-of-phase drive currents or by connecting A1 and A2 and/or B1 and B2 to unequal and out-of-phase electrical loads.

14. The rotating electrical machine of claim 10, wherein:
a center of mass of the rotor and a center of the magnetic field provided by the magnet array are offset from a center of the magnetic fields generated by the stator control coils; and
rotation of the rotor about the X axis and the Y axis is controlled by driving one of A1, A2, B1, or B2.

15. A method of providing multi-axis control in a rotating electrical machine, the method comprising:
providing a rotating electrical machine comprising a stator assembly having multiple stator control coils and a rotor having a magnet that provides a magnetic field that passes through the stator control coils, wherein the rotor has at least two degrees of freedom, including a first degree of freedom including rotation about a Z axis, and any one or more of:
a second degree of freedom including translation along the Z axis;
a third degree of freedom including rotation about an X axis perpendicular to the Z axis;
a fourth degree of freedom including translation along the X axis;
a fifth degree of freedom including rotation about a Y axis perpendicular to each of the X and Z axes; and
a sixth degree of freedom including translation along the Y axis axes;
operating the stator control coils to control the rotor with respect to the first degree of freedom, including increasing or decreasing a rotational rate of the rotor about the Z axis, wherein the rotating electrical machine functions as an electrical motor or an electrical generator by rotation of the rotor about the Z axis; and
operating at least some of the same stator control coils that control the rotor with respect to the first degree of freedom to control the rotor with respect to any one or more of the first, second, third, fourth, fifth, or sixth degrees of freedom.

16. The method of claim 15, further comprising:
collecting upper position data indicating a position of an upper end of the rotor with respect to the stator assembly; and
collecting lower position data indicating a position of a lower end of the rotor with respect to the stator assembly;
wherein the at least some of the stator control coils are operated to control the rotor with respect to any one or more of the first, second, third, fourth, fifth, or sixth degrees of freedom based on one or both of the upper position data or the lower position data.

17. The method of claim 15, wherein the magnet array comprises a dipolar cylindrical Halbach array.

18. The method of claim 15, wherein operating the stator control coils to control the rotor with respect to the first degree of freedom comprises driving each of the stator control coils with equal and in-phase drive currents or by connecting each of the stator control coils to equal and in-phase electrical loads.

19. The method of claim 15, further comprising operating the stator control coils to control the rotor with respect to each of the third, fourth, fifth, and sixth degrees of freedom.

20. The method of claim 19, further comprising operating the stator control coils to control the rotor with respect to the second degree of freedom including translation along the Z axis.
